(19) United States
(12) Patent Application Publication
(10) Pub. No.: US 2023/0392865 A1
(43) Pub. Date: Dec. 7, 2023

(54) ENHANCED FREEZE-DRY TRAY WITH DOUBLE SUBLIMATION FRONT AND INTEGRATED DRAINAGE SYSTEM FOR FASTER LYOPHILIZATION

(71) Applicant: Charles MacGowan, Miami, FL (US)

(72) Inventor: Charles MacGowan, Miami, FL (US)

(21) Appl. No.: 18/236,478

(22) Filed: Aug. 22, 2023

(51) Int. Cl. F26B 5/06; F26B 9/00; F26B 25/18

(52) U.S. Cl. CPC F26B 5/06; F26B 25/18; F26B 9/003

(57) ABSTRACT

The invention introduces a freeze-drying tray apparatus designed to optimize the freeze-drying process. The apparatus features a tray frame purposed to contain a slurry. Integral to this frame is a distinctive permeable tray bottom, fashioned from a sintered mesh. This mesh comprises a minimum of three layers, each with its unique porosity level. This design facilitates dual actions: the effective drainage of surplus water and the enabling of sublimation directly from the tray's bottom Enhancing the tray's structural integrity and functionality, a metal frame is seamlessly welded to this multi-layered sintered mesh, ensuring durability and efficiency in the freeze-drying process.

### FIELD OF THE INVENTION

The present invention relates to the field of lyophilization equipment and methods, specifically to an enhanced freeze-drying tray designed to efficiently remove moisture. The invention is particularly beneficial for processing products with high water content, such as botanical trichomes extracted using solventless Ice Water Extraction (IWE) or Cold-Water Extraction (CWE) methods.

### BACKGROUND

Lyophilization, known as freeze-drying, has been a cornerstone in preserving various perishable materials. The process encompasses freezing the material, followed by a reduction in surrounding pressure. This reduction enables the frozen water within the material to sublimate, transitioning directly from a solid state to a gaseous state. While this technique is advantageous for long-term storage and preservation, it does come with its set of challenges.

A predominant challenge in lyophilization is the duration it demands, particularly when confronted with materials that have a high-water constitution. One such example are botanical trichomes, which, when extracted using solventless methods like Ice Water Extraction (IWE) or Cold-Water Extraction (CWE), retain a significant amount of water in a slurry. This water content, although essential for the formation of ice crystals that eventually aid in the sublimation process, extends the freeze-drying duration.

Traditional solid metal lyophilization trays are designed with a simplistic approach. When these trays are employed, the sublimation predominantly occurs on the exposed surface of the material. As this surface undergoes drying, the sublimation front, or the active region where water is sublimating, delves deeper into the product. While this ensures the gradual drying of the product, it inherently limits the thickness of the material that can be effectively sublimated. The reason for this limitation lies in the necessity for water to find channels or pathways within the material to escape and undergo sublimation.

Standard trays utilized in the lyophilization process are often crafted from solid metal sheets. These trays are inherently designed with a single exposure point for sublimation. Their solid nature does not permit the passage or draining of excess water from the material placed on them. Consequently, the sublimation process predominantly commences from the exposed surface of the product, moving inwards over time. This single-front sublimation often restricts the thickness of products that can be effectively lyophilized, as water requires pathways within the material to escape and undergo sublimation.

An alternative approach to tackle the excess water problem involves the use of silk screen frames or other mesh type products. While these frames effectively drain surplus water, their application is not without its challenges. For starters, silk screen frames are incompatible with direct usage within freeze dryers. This necessitates the transfer of the product from the silk screen frame to a traditional freeze-drying tray, introducing added complexities and steps to the lyophilization process. Furthermore, the plastic mesh base of these frames is not particularly conducive to heat transfer, leading to a diminished lyophilization rate. This delicate and intricate mesh is susceptible to damage during handling and operations. Moreover, the extreme flatness of the mesh-bottomed tray hampers the formation of a secondary sublimation front, primarily because of the absence of a gap between the tray and the freeze-dryer shelf.

In the context of botanical trichomes and other similar substances extracted via a water process, the material is presented as a slurry on the tray. The approach aims to achieve a level surface, promoting consistent drying across the material. However, the process is nuanced; while there is a need to retain sufficient water to instigate the formation of ice crystals (which in turn carve out channels for water to escape during sublimation), there is also a need to mitigate the overall water content. These ice crystals are imperative for ensuring uniform sublimation, particularly from traditionally challenging regions, such as the base and center of the material. Yet, an excessive water presence in the slurry directly correlates with elongated sublimation durations, presenting a need for balance and, perhaps, innovation in the lyophilization tray design.

Against this backdrop, the present invention has been developed to address the intricacies of lyophilization, particularly for materials like botanical trichomes derived from solventless extraction methods. This detailed backdrop underscores the pressing need for innovation in the freeze-drying tray design, especially one that balances the necessity to remove excess water and ensures optimal sublimation rates. The proposed method, with its permeable bottom and dual sublimation fronts, offers a promising solution to these longstanding challenges in the realm of lyophilization.

### BRIEF SUMMARY

The objective of the present invention is to disclose a design of an advanced freeze-dry tray that not only increases the sublimation front, effectively doubling its surface area but also incorporates a mechanism to drain excess water from the product. This dual approach aims to reduce the lyophilization cycle time significantly.

In an embodiment, the new tray design incorporates a secondary layer positioned to allow both the upper and lower sublimation fronts to be exposed to the sublimation process. Each layer ensures equal distribution of cold temperatures, thereby optimizing the sublimation process. This design effectively doubles the surface area exposed for sublimation, accelerating water removal in the form of vapor.

In an embodiment, the tray features strategically positioned perforations, channels, or mesh structures designed to facilitate excess water drainage before the freeze-drying process. This draining mechanism ensures that a significant portion of the water is removed before sublimation begins, reducing freeze-drying time. The drainage system is especially beneficial when dealing with products like trichome slurry from IWE or CWE methods, which often have high water content.

Unlike conventional trays, the disclosed tray is innovatively designed with a permeable bottom. After the slurry is poured onto this tray, the permeable nature of the bottom allows excess water to seep through and out of the product. The importance of this step is twofold: (1) Efficiency in Lyophilization: By allowing the excess water to permeate through, the overall water content in the product is reduced. As a result, when the freeze-drying process is initiated, there's less water to sublimate, which translates to faster lyophilization times. (2) Retention of Interstitial Spaces: Even as excess water seeps out through the permeable bottom, the surface tension of the water ensures that small spaces or channels are retained within the product. These spaces are crucial as they provide pathways for the remaining water to sublimate effectively throughout the entirety of the product.

Traditional trays used in lyophilization have an impermeable bottom, which means they are solid and do not allow any moisture to pass through. As a result, with these standard trays, the sublimation or transition of water from solid ice to vapor occurs solely from the exposed top surface of the product. This sublimation front then moves progressively downward and into the product, drying layer by layer. It's a unidirectional drying process. However, the disclosed method redefines this process. The permeable bottom of the tray design allows the creation of an additional sublimation front at the bottom of the product. In essence, the product dries from both the top and the bottom simultaneously. This bidirectional drying promotes faster and more efficient sublimation and significantly reduces the overall drying time.

The dual-front lyophilization method is a groundbreaking approach that optimizes the freeze-drying process, ensuring faster and more efficient drying, which is especially beneficial for products with substantial water content. The tray promises a significantly faster freeze-drying cycle by combining the double sublimation front and the integrated drainage system, allowing producers to optimize production timelines. Faster lyophilization cycles can potentially lead to better preservation of the active components in the freeze-dried material, ensuring a higher-quality end product. While the tray is designed explicitly with trichome production in mind, its innovative features can be beneficial in other industries where freeze-drying is utilized, such as food processing or pharmaceuticals.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a diagram that illustrates a freeze-drying tray design in accordance with an embodiment of the present invention.

FIGS. 2-4 are diagrams that illustrate various perspective views of the freeze-drying tray in accordance with an embodiment of the present invention.

FIG. 5 is a diagram that illustrates the arrangement of a filter paper within a freeze-drying tray in accordance with an embodiment of the present invention.

FIG. 6 is a diagram that illustrates the controlled pouring of slurry onto the freeze-drying tray in accordance with another embodiment of the present invention.

FIG. 7 is a diagram that displays the resulting frozen state of the poured slurry, as part of the innovative freeze-drying process, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to limit the scope of the invention necessarily.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated relative to other elements, to improve the understanding of the present invention. Additional components that are not depicted in one of the described drawings may be described in the foregoing application. In the event such a component is described but not depicted in a drawing, the absence of such a drawing should not be considered as an omission of such design from the specification.

Before describing the present invention in detail, it should be observed that the present invention utilizes a combination of components or set-ups, which constitutes the introduction of a new design for a freeze-drying (lyophilization) tray which will not only increase the surface area for sublimation but also aid in draining excess water during the extraction process. The goal of this invention is to design an advanced freeze-dry tray that not only increases the sublimation front, effectively doubling its surface area, but also incorporates a mechanism to drain excess water from the product. This dual approach aims to reduce the lyophilization cycle time significantly. Accordingly, the components have been represented, showing only specific details pertinent for understanding the present invention so as not to obscure the disclosure with details readily apparent to those with ordinary skill in the art having the benefit of the description herein. As required, detailed embodiments of the present invention are disclosed herein; however, it is understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” are used to arbitrarily distinguish between the elements. Thus, these terms are not necessarily intended to indicate temporal or other prioritization of such elements. While various exemplary embodiments of the disclosed invention have been described below it should be understood that they have been presented for purposes of example only, not limitations. It is not exhaustive and does not limit the invention to the precise form disclosed. Modifications and variations are possible considering the above teachings or may be acquired from practicing of the invention, without departing from the breadth or scope.

Lyophilization, or freeze-drying, is a method for preserving various products, including botanical extracts. The efficiency of the process depends heavily on the speed of sublimation, which is the direct conversion of ice into vapor without passing through the liquid phase. For products such as trichomes obtained through solventless Ice Water Extraction (IWE) or Cold-Water Extraction (CWE), the lyophilization process can be time-consuming due to the product's high-water content. Traditional freeze-drying trays are constructed with an impermeable solid bottom. When a slurry, which is a mixture of the product and its water content, is poured onto such trays, the drying process is inherently one-dimensional. Water sublimates from the top surface, creating a sublimation front that progressively moves downward. This approach results in a unidirectional drying mechanism, limiting the speed of the overall freeze-drying process.

Innovation in Tray Design: The proposed freeze-dry tray is ingeniously designed to double the sublimation front, effectively enhancing the drying process. Unlike conventional trays, the disclosed tray is equipped with a permeable bottom. When the slurry is poured onto this tray, the permeable nature enables the excess water to seep out. This pre-emptively reduces the water content and prepares the product for a more efficient lyophilization process. As the excess water drains, the natural surface tension of the remaining water ensures the retention of tiny spaces or channels within the product. These channels facilitate a uniform and efficient sublimation process throughout the product. The feature of the disclosed tray is its ability to simultaneously initiate the sublimation process from both the top and bottom of the product. This is possible due to the permeable bottom. As the product starts freeze-drying, water vapor sublimates from both surfaces. This bidirectional approach drastically reduces the drying time, making the lyophilization cycles faster.

Benefits and Applications: (1) With two active sublimation fronts, the lyophilization process becomes notably faster, beneficial for large-scale operations, and ensures product quality. (2) While this tray design finds immediate application in drying botanical trichomes from IWE or CWE extracts, its benefits can be extended to other products requiring freeze-drying. (3) Faster lyophilization cycles could mean lower operational costs in the long run, especially in energy-intensive industries. (4) A quicker drying process reduces the product's exposure time in the freeze-dryer, potentially improving the final product's quality.

In summary, the disclosed innovative tray design represents a significant advancement in the field of lyophilization, promising faster drying times, better product quality, and operational efficiency.

The invention will now be described with reference to the accompanying drawings, which should be regarded as merely illustrative without restricting the scope and ambit of the present invention.

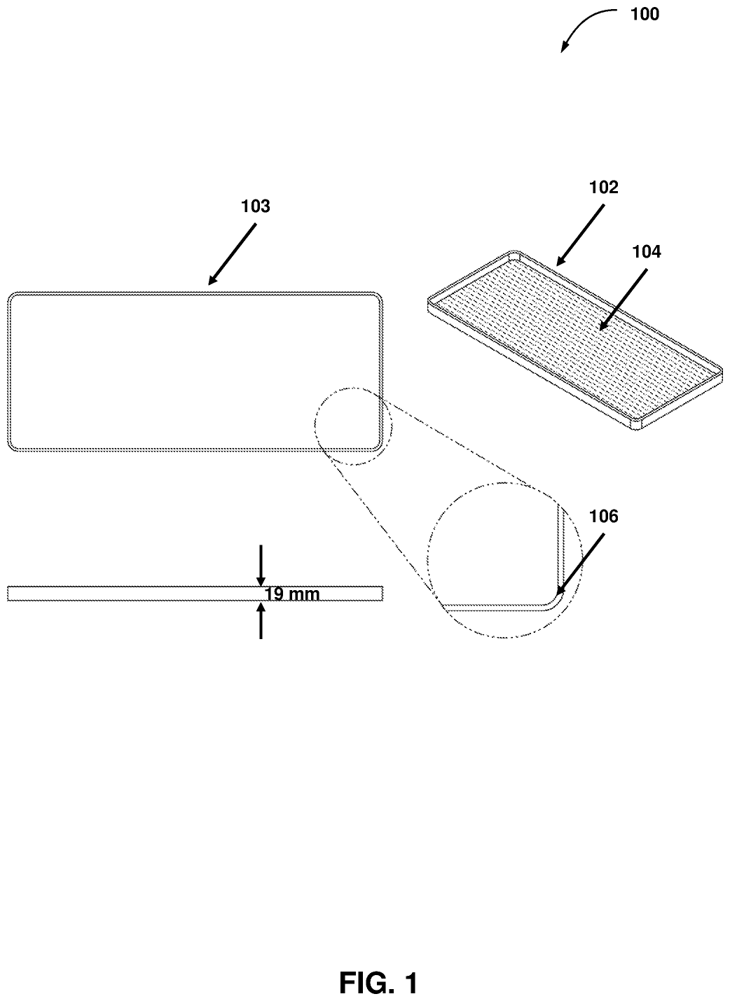

FIG. 1 is a diagram 100 that illustrates a freeze-drying tray design in accordance with an embodiment of the present invention. FIG. 1 provides a visual representation, diagram 100, detailing the design specifics of a novel freeze-drying tray 102, particularly suited for enhancing the freeze-drying process. The freeze-drying tray 102 includes a tray frame 103 and a permeable tray bottom 104.

Tray Frame 103: tray frame 103 is a rectangular tray frame, for example, with a length measuring 518 mm and a width of 220 mm. This provides a spacious surface area suitable for accommodating significant product quantities. The tray frame 103 is defined by four sides. In one exemplary embodiment, each side stands at a height of 19 mm, ensuring the contents remain well-contained. The width or thickness of each side is 2.75 mm, providing stability to the structure. The tray frame 103 is constructed from 316L SS (Stainless Steel). 316L SS is known for its superior corrosion resistance, especially against chlorides and other industrial solvents. Its utilization ensures that the tray is durable and safe for freeze-drying operations. The tray features smooth, rounded corners. This design minimizes the potential for product accumulation in sharp corners, ensuring an efficient freeze-drying process and facilitating easier cleaning.

Permeable Tray Bottom 104: the tray bottom 104 is not a typical solid base. Instead, it is constructed using a sintered mesh. Sintering is a process where particles are fused together via heat, resulting in interconnected pores. This mesh is metallic, aligning with the robust nature of the tray. The permeable nature of the sintered mesh means that while it supports the product, it also allows for the passage of water vapor. This design aligns with the innovative feature of allowing bidirectional sublimation from both the top and the bottom of the product. The product is designed using a specialized sintered mesh composed of three or more layers, each with different porosity levels. This multi-layered approach ensures nuanced control over the flow and filtration processes. The chosen materials for constructing this mesh include durable metals like titanium or steel, known for their resilience and longevity. To convert this mesh structure into a functional tray, a sturdy metal frame is meticulously welded around it, providing structural support and defining the tray's boundaries. To enhance its finish, corrosion resistance, and hygiene, the product might undergo an electropolishing process that smoothens and polishes metal surfaces at a microscopic level, leaving them with a gleaming and clean finish.

Examples for Practical Application: Suppose a pharmaceutical company is freeze-drying a liquid medicine to convert it into a powder form. The medicine is poured as a slurry onto the freeze-drying tray 102. Due to the permeable tray bottom 104, as the freeze-drying process starts, water vapor from the medicine will begin to sublimate from the top surface and the bottom. The sintered mesh aids in this dual sublimation, ensuring an even and faster drying process. Additionally, given the tray's specific dimensions, it could be designed to fit perfectly within industry-standard freeze dryers, ensuring compatibility and ease of use.

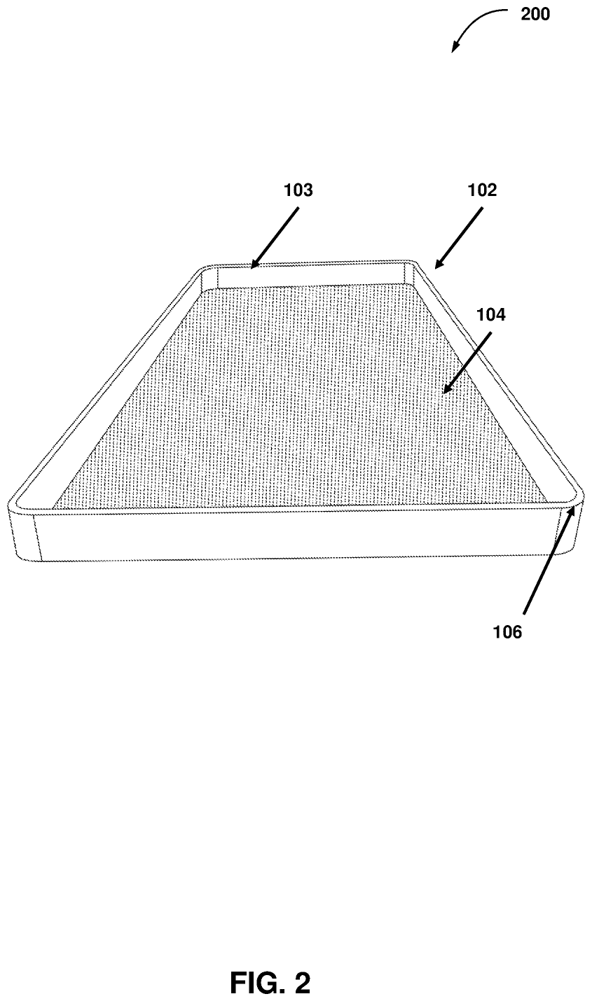

FIGS. 2-4 are diagrams 200, 300, and 400 that illustrate various perspective views of the freeze-drying tray 102, in accordance with an embodiment of the present invention. FIG. 2 provides a three-dimensional (3D) perspective of the freeze-drying tray 102, offering viewers a comprehensive spatial understanding of the tray's design and its components. In this 3D view, the tray frame 103 can be observed from multiple angles, allowing viewers to appreciate the depth, width, and length of tray 102. This visualization aids in understanding the tray's capacity and the space it provides for contents. The rounded corners 106 of the tray frame 103 are more apparent in the 3D view. This design ensures that no sharp edges are present, minimizing product accumulation and facilitating easier cleaning. The 3D view clearly visualizes how the permeable tray bottom 104 sits within tray frame 103. The sintered mesh construction of the bottom becomes evident, showcasing its porous nature. This design allows viewers to understand how the tray bottom 104 can support the product while permitting the passage of water vapor during the freeze-drying process.

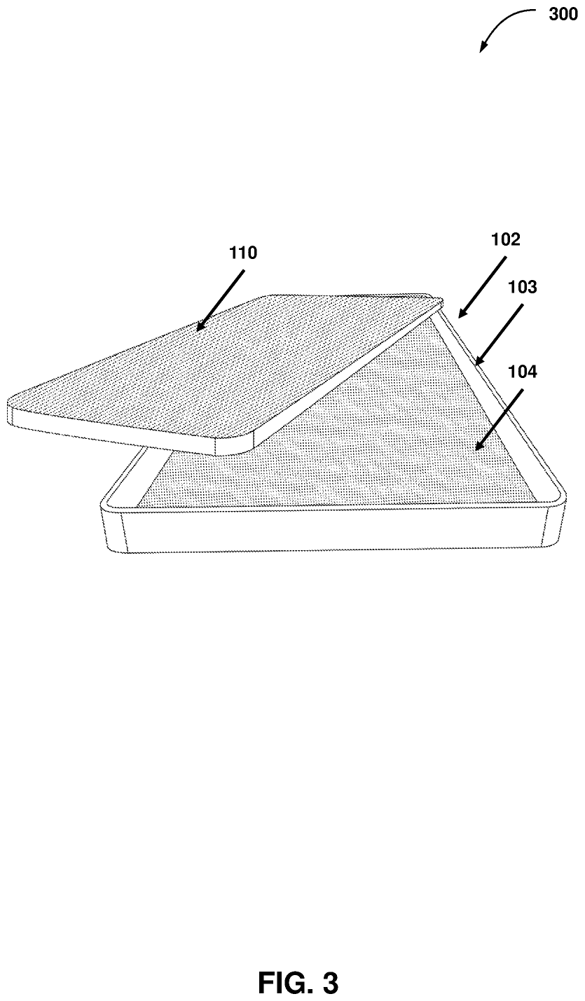

In FIG. 3, a 3D view vividly presents the freeze-drying tray 102, incorporating three primary components: the tray frame 103, the permeable tray bottom 104, and a new element, the permeable tray lid 110. The tray frame 103, constructed from durable 316L Stainless Steel, provides a robust structure and defines the tray's dimensions. Nestled within this frame, the permeable tray bottom 104 features a sintered mesh design, allowing efficient water vapor passage during lyophilization. Adding the permeable tray lid 110 helps prevent contaminants from falling on the product while enabling water vapor to escape from both the top and bottom, allowing more rapid and uniform freeze-drying.

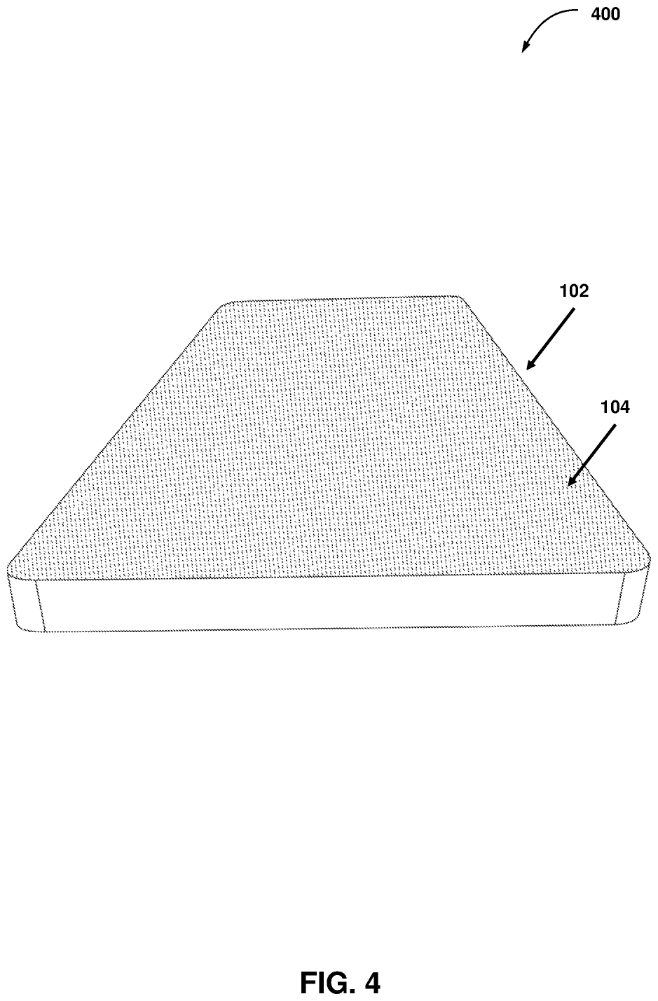

FIG. 4 provides a unique bottom perspective of the freeze-drying tray 102, offering an inverted viewpoint where the permeable tray bottom 104 is prominently visible at the top. This vantage point allows for a closer examination of the sintered mesh design of the permeable bottom, highlighting its intricate construction and porous nature. Through this visualization, one can better understand how the tray facilitates the efficient passage of water vapor, which is essential for the accelerated lyophilization process. This angle can also glean the tray's underlying structure and how it seamlessly integrates with the tray frame.

In an embodiment, tray frame 103 plays a crucial role in holding the product during lyophilization. By providing a barrier for the slurry, frame 103 ensures that users can pour a substantial and thick layer of product onto tray 102 without spillover. This containment is essential to maintain uniformity in the freeze-drying process and to ensure consistent product quality. Without such a barrier, there's a risk of uneven spread or loss of product.

In an embodiment, the permeable tray bottom 104 is an innovative feature that facilitates the removal of excess water and supports the sublimation process during freeze-drying. The tray bottom's unique construction permits excess water to drain out from the poured slurry. This is pivotal in reducing the moisture content before the commencement of the freeze-drying, ensuring a faster and more efficient process. Beyond just drainage, the tray bottom's permeable nature also allows for water's sublimation. Sublimation is the transition of water from its solid (ice) phase to vapor without passing through the liquid phase. The process becomes expedited and more effective with two sublimation fronts, the top and the bottom. The smooth inner surface of the permeable bottom is intentionally designed to prevent product particles from getting lodged or stuck on the tray. This is vital for product quality and ensures easy cleaning and maintenance of the tray after usage. In contrast, the textured outer surface of the permeable bottom serves a different yet equally important purpose. This texture acts as a separator between the tray and the freeze-drier shelf. By providing a slight gap or separation, it ensures that there's enough space for water vapor to move freely, optimizing the sublimation process. This ingenious design element prevents the tray from sticking to the freeze-drier shelf, ensuring smooth operation during and after the lyophilization cycle.

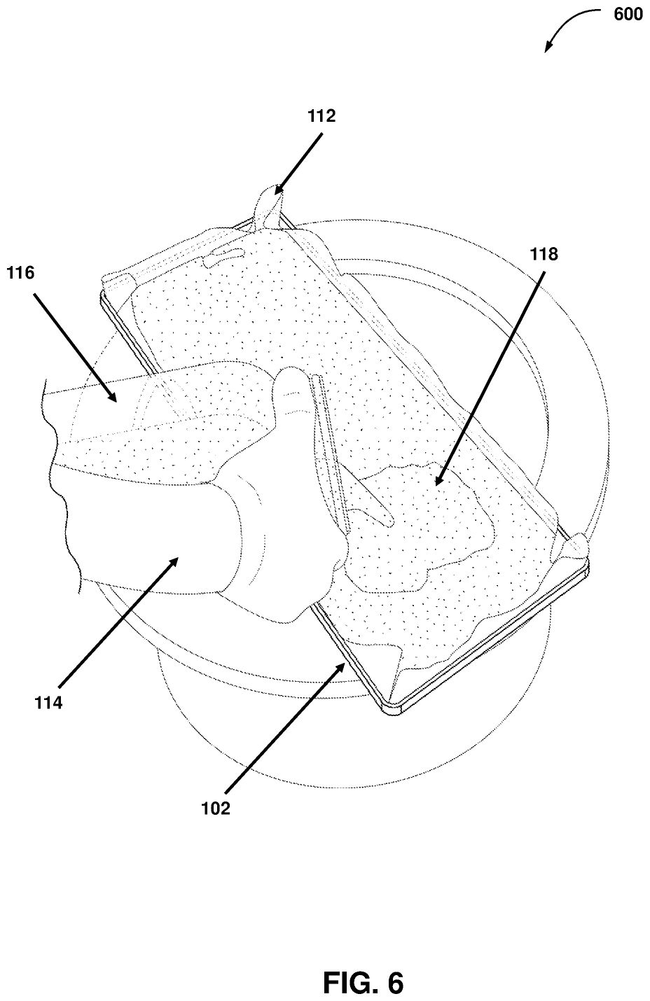

The proposed method revolutionizes the freeze-drying process by making a two-fold advancement in the design of the freeze-drying tray 102. The process starts by pouring a fluid slurry onto tray 102 (as shown in FIG. 6). Just like traditional methods, the aim is to create a flat, even surface, which ensures uniform drying. An uneven surface might lead to inconsistencies in the final product, as certain portions might dry faster than others. Unlike conventional trays, this tray 102 is equipped with a permeable bottom. The significance of this design becomes evident immediately after the slurry is poured. The excess water, which usually remains trapped in conventional methods, starts to permeate or drain through this permeable bottom due to gravity and the intrinsic nature of the material. By allowing the excess water to drain out before the freeze-drying process begins, the overall moisture content that needs to be sublimated is reduced. This directly translates to a reduction in the freeze-drying or lyophilization time, making the process more efficient. As the excess water drains out, the surface tension of the remaining water in the slurry helps maintain the interstitial spaces within the product. These spaces are crucial as they act as pathways or channels for the water to sublimate effectively throughout the product.

Traditional freeze-drying trays come with a limitation. With their impermeable bottoms, the water in the product can only sublimate from the top surface, forming just one sublimation front. This top-down sublimation is time-consuming as the drying front slowly moves inward. However, with the proposed method, the permeable tray design introduces a second sublimation front at the bottom. This simultaneous dual-front sublimation drastically increases the efficiency of the drying process. With water sublimating from the product's top and bottom, the drying process is considerably accelerated. This means shorter sublimation times and potentially leads to a more uniformly dried product, as all parts of the slurry are exposed to the sublimation process equally.

In summary, the disclosed invention pertains to the freeze-drying tray apparatus 102, which is innovatively designed to enhance the freeze-drying process. The primary component of this apparatus is a tray frame (103) built to hold a slurry. This frame integrates a unique permeable tray bottom (104) crafted from a layered sintered mesh, consisting of three or more layers with distinct porosity levels. The purpose of this design is two-fold: to drain excess water and to facilitate sublimation from the bottom of the tray. The mesh materials range from titanium to steel, and the entire product may undergo an electropolishing process to ensure a smoother finish and enhanced corrosion resistance. This apparatus stands out due to specific design features. For instance, the tray frame (103) consists of four sides, each meticulously measured for optimal performance. The permeable tray bottom is skillfully designed with a smooth inner surface to prevent particles from lodging, and its textured outer surface ensures separation from the freeze-drier shelf, promoting efficient sublimation. Further elevating its utility, it is possible to incorporate a permeable tray top (110), which, when paired with the bottom, establishes dual sublimation fronts, drastically accelerating drying times. The tray is compatible with filter paper, mesh, cloth, or fabric (112) to allow easy cleaning and product removal from the tray. Beyond these features, the tray harnesses the surface tension of water to retain the necessary spaces, ensuring that water sublimates efficiently throughout the product. The tray's design prioritizes user safety, evidenced by rounded corners and a durable 316L stainless steel construction. Moreover, its mesh is tailored for optimal water drainage and sublimation due to its varied porosity. Lastly, this tray apparatus promises consistency in freeze-drying, especially when handling slurries pre-sorted to specific particle sizes.

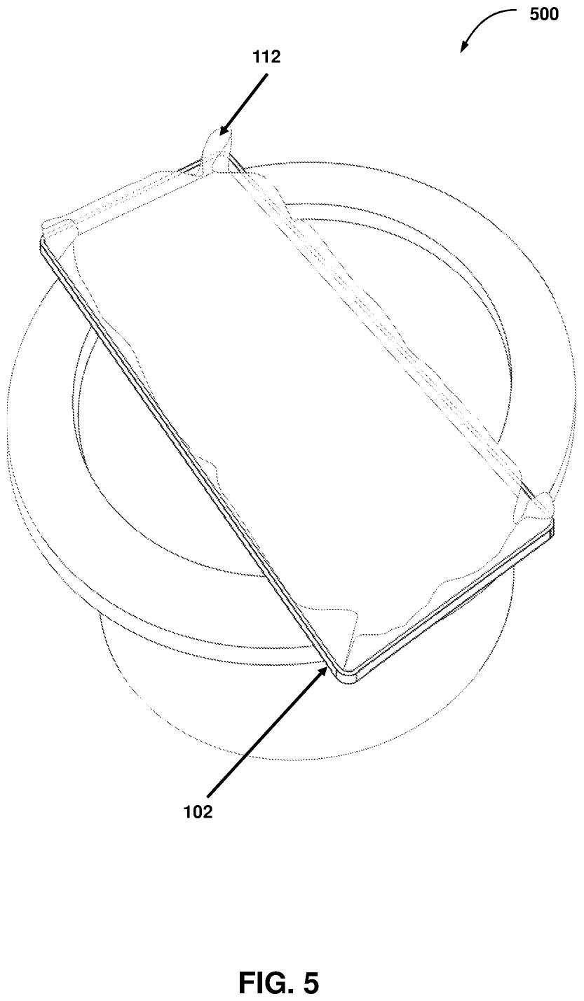

FIG. 5 is a diagram 500 that illustrates the arrangement of a filter fabric 112 within a freeze-drying tray 102, in accordance with an embodiment of the present invention. In FIG. 5, a detailed depiction of the freeze-drying tray 102 has been shown. Inside tray 102, a critical component, filter fabric 112, has been introduced. The filter fabric 112 is not just haphazardly thrown into tray 102. Instead, it's methodically aligned to snugly fit and cover the entire interior surface of tray 102. This ensures that the entire base area of the tray is overlaid by the filter paper, which hints at its significant role in the upcoming stages of the process. The filter fabric 112 likely acts as a preliminary barrier, preventing any minute, sticky or undesired particles in the slurry from lodging or sticking to the tray bottom. This filtration ensures that only the clean, essential constituents of the slurry move forward in the freeze-drying process. With its porous nature, the filter fabric 112 might aid in spreading the slurry evenly across the tray's surface. An even distribution is crucial for achieving consistent drying during lyophilization. Given the tray's permeable bottom, the filter fabric 112 can assist in the controlled draining of excess water. It might act as a mediator, absorbing excessive moisture initially and then allowing it to drain or sublimate in a controlled manner, enhancing the overall efficiency of the freeze-drying process. The filter fabric 112 can also provide a protective layer between the slurry and the permeable bottom of tray 102. This ensures that the tray's meshed or porous structure remains unblocked, facilitating optimal sublimation from both the top and bottom fronts.

FIG. 6 is a diagram 600 that illustrates the controlled pouring of slurry 118 onto the freeze-drying tray 102, in accordance with another embodiment of the present invention. FIG. 6 visualizes a defining moment in the freeze-drying procedure. Here, a user designated as 114 is actively introducing the slurry 118 to the freeze-drying tray 102. The depiction details the user 114 wielding a slurry bottle 116. With deliberate precision, user 114 pours the slurry 118—a semi-fluid mixture containing the components desired for freeze-drying—onto tray 102. The pour's trajectory and the user's positioning suggest an intention to distribute the slurry 118 as uniformly as possible over the tray's expanse. The underlying filter fabric 112, previously set within the tray as indicated in FIG. 5, becomes the initial recipient of the slurry, ensuring an even spread and possibly preventing any large or undesired particles from settling. As slurry 118 is introduced, the previously positioned filter paper 112 serves as a mediator, aiding in spreading the mixture uniformly. It likely also plays a role in absorbing excess moisture, ensuring that the slurry's consistency remains optimal for the freeze-drying process.

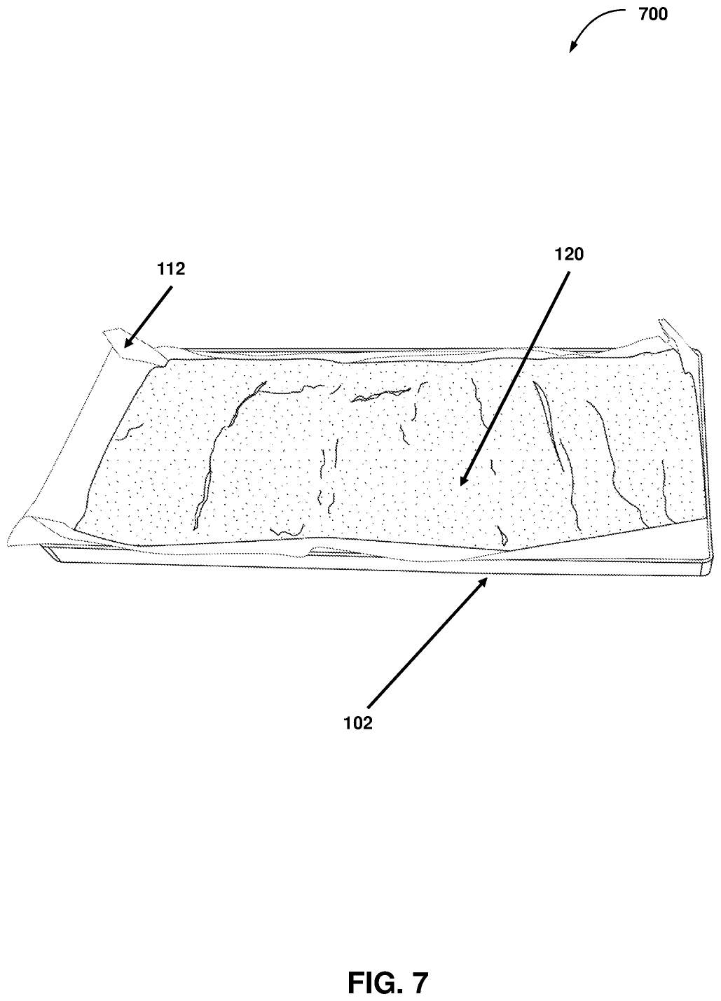

FIG. 7 is a diagram 700 that displays the resulting frozen state of the poured slurry, as part of the innovative freeze-drying process, in accordance with an embodiment of the present invention. FIG. 7 vividly illustrates the next essential step in the freeze-drying process: the transition of the slurry from its initial liquid form to a solid frozen state, designated as 120. This transformation is of utmost importance, setting the stage for the following pivotal sublimation process. After receiving the slurry, the freeze-drying tray is subjected to controlled freezing conditions. This causes the slurry, once a semi-liquid mixture, to solidify, as shown by the uniform solid structure represented by 120. The appearance of the frozen slurry may be consistent and homogeneous, showcasing that the slurry has been evenly distributed and adequately frozen.

Step-by-step Process Explanation:
1. Sort the product to be dried to a particle size larger than the tray's aperture: Before the freeze-drying process begins, it's essential to ensure that the size of the product particles is suitable for the tray being used. This means the product particles should be larger than the tray's tiny openings (or apertures). For example, let's say the tray's aperture size is 0.5 mm. If you're processing strawberries, you would slice or dice them such that each piece is larger than this 0.5 mm measurement, preventing them from passing through the tray openings.
2. Prepare a slurry of product and liquid. The temperature of the slurry and tray must be appropriate for the product being processed. A slurry is a semi-liquid mixture typically made of fine particles suspended in a liquid. It's vital to ensure that both the slurry and the tray are at a temperature conducive to freeze-drying. For Example, when preparing a slurry of botanical trichomes and water, one might cool the mixture to 1° C. to ensure particles don't melt and achieve effective freeze-drying.
3. Agitate the slurry to suspend all solids. Pour the suspended solids onto the tray. Care must be taken to pour the product evenly to create an even surface. Mixing the slurry ensures that the solid particles are uniformly distributed within the liquid. This results in a consistent distribution when poured onto the tray. For example, using a stirrer, one might agitate a slurry of botanical trichomes in water to ensure all particles are suspended, then pour it onto the tray, ensuring the surface is smooth and devoid of lumps.
4. Allow the product to drain thoroughly. Terry cloth or paper products can be used to wick excess moisture off the bottom of the tray. Letting the product drain removes excess liquid, which aids in quicker and more effective freeze-drying. Using absorbent materials like terry cloth or paper can expedite this process. For example, after pouring a slurry of botanical trichomes onto the tray, one could place a terry cloth beneath the tray, allowing it to absorb any dripping water, ensuring that the tray does not freeze onto the freezedrier shelf due to excess water.
5. Once the product is prepared, it is placed inside a freeze drier. Place the tray inside the freeze drier and follow the equipment manufacturer's instructions. Following the manufacturer's guidelines ensures optimum drying and preserves the product's quality. For example, if freeze-drying a tray of shrimp, you′d set the freeze drier to a specific temperature and pressure setting recommended by the manufacturer for seafood to ensure it retains its flavor and nutritional content.
6. Once the machine cycle is complete, the process is complete. The freeze-drying process is considered complete when the freeze-drier has run its course and achieved the desired level of moisture removal from the product. For example, after running the freeze drier for the recommended time for a batch of sliced bananas, you′d find the bananas crisp, dry, and ready for storage or consumption, marking the end of the freeze-drying process.

The disclosed innovative freeze-drying tray 102 offers substantial enhancements in the lyophilization process, demonstrated by its ability to slash drying times from a lengthy 24 hours to a mere 8 hours, contingent on the product amount. This expedited drying not only retains a greater proportion of aromatic compounds like terpenes, ensuring superior product quality but also allows for a higher solid load on the tray, effectively augmenting the freeze drier's capacity. Furthermore, by decreasing the water content that the freeze drier has to process, our device significantly amplifies operational efficiency, heralding a new era in freeze-drying technology.

Although the present invention has been described with respect to various schematic representations (FIGS. 1-7), the proposed freeze-drying tray 102 can be realized and implemented with varying shapes and sizes. Thus, the present invention here should not be considered limited to the exemplary embodiments and processes described herein. The various dimensions may be modified to fit specific application areas. Although particular embodiments of the invention have been described in detail for illustration purposes, various modifications and enhancements may be made without departing from the spirit and scope of the invention.

What is claimed is:

1. A freeze-drying tray apparatus comprising:
a tray frame (103) configured to provide a barrier for a slurry; and
a permeable tray bottom (104) integrated into said tray frame (103), wherein the permeable tray bottom (104) is constructed from a sintered mesh of three or more layers with varying porosity, allowing both drainage of excess water and sublimation from the bottom.

2. The freeze-drying tray apparatus of claim 1, wherein the sintered mesh is fabricated from materials selected from the group consisting of titanium or steel.

3. The freeze-drying tray apparatus of claim 1, wherein the tray frame (103) includes four sides, each having a height of 19 mm and a width of 2.75 mm.

4. The freeze-drying tray apparatus of claim 1, wherein the permeable tray bottom (104) incorporates a smooth inner surface to deter the lodging of particles.

5. The freeze-drying tray apparatus of any preceding claim, wherein the permeable tray bottom (104) possesses a textured outer surface, enabling separation from a freeze-drier shelf, facilitating efficient water sublimation.

6. The freeze-drying tray apparatus of claim 1, further comprising a permeable tray top (110) positioned opposite the permeable tray bottom (104), creating dual sublimation fronts for enhanced drying.

7. The freeze-drying tray apparatus of claim 6, wherein said tray reduces lyophilization times by facilitating both top and bottom sublimation fronts, resulting in efficient drying.

8. The freeze-drying tray apparatus of claim 1, designed to accommodate a filter fabric (112) within, which aids in an even distribution of slurry poured onto the tray and assists in cleaning and product removal.

9. The freeze-drying tray apparatus of claim 1, further comprising rounded corners on each side of the tray frame (103), ensuring safer handling, and reducing the risk of damage to surrounding objects or users.

10. The freeze-drying tray apparatus of claim 1, wherein the layered sintered mesh of the permeable tray bottom (104) incorporates varying levels of porosity, enabling the optimization of water drainage and sublimation capabilities.
